(19) United States
(12) Patent Application Publication
(10) Pub. No.: US 2025/0234959 A1
(43) Pub. Date: Jul. 24, 2025

(54) SHOE UPPER AND MANUFACTURING METHOD THEREOF

(71) Applicant: Amplifi Tech (Xiamen) Limited, Xiamen (CN)

(72) Inventor: LI WEI CHEN, Taoyuan City (TW)

(21) Appl. No.: 18/964,599

(22) Filed: Dec. 1, 2024

(30) Foreign Application Priority Data
Jan. 22, 2024 (CN) 202410089077.4

(51) Int. Cl. A43B 23/02; A43B 23/07

(52) U.S. Cl. CPC A43B 23/0235; A43B 23/07

(57) ABSTRACT

A shoe upper of the present disclosure comprises a non-woven layer. The non-woven layer has an outline pattern and comprises a plurality of yarn segments, as well as a covering structure. The plurality of yarn segments is stacked to form the outline pattern without penetrating through a base layer. Each of the yarn segments comprises a first end and a second end opposite to each other, wherein the first end and the second end are open ends located at an edge of the outline pattern. The covering structure directly covers the yarn segments and fixes the position of the yarn segments, wherein the thickness of the covering structure on each of the yarn segments ranges from 0.01 mm to 1.5 mm. The non-woven layer has a tensile strength larger than 90 N/cm.

### CROSS-REFERENCE TO RELATED APPLICATION

The instant application claims priority to China Patent Application 202410089077.4, filed on Jan. 22, 2024, which is incorporated herein by reference.

### BACKGROUND

### Field of Disclosure

The present disclosure relates to a shoe upper and the manufacturing method thereof.

### Description of Related Art

Generally, a footwear product comprises a shoe sole and a shoe upper that is fixed on the shoe sole, wherein shoe uppers currently available and made of non-leather materials are mostly formed by knitting or weaving methods. Moreover, different areas of the shoe upper are usually designed for having different functions corresponding to different parts of the foot. Therefore, in general, more than one type of material and more than one kind of knitting or weaving method, with the coordination of several components in some cases, are used for meeting the requirements to achieve the comprehensive design of a shoe upper. During the manufacturing process of shoe uppers, multiple manufacturing processes or manual labor are required frequently to complete the whole shoe uppers. Meanwhile, a vast amount of waste is generated from cutting or assembling parts. Yarns with interlocking structures, created by weaving, knitting, and interlacing processes, can easily add an additional weight to the shoe upper. In view of the aforementioned problems regarding the prior art, how to provide a shoe upper of lightweight, high mechanical strength, and high comfort of wearing that can be produced by a simple and cost-saving manufacturing method is one of the goals under active research by people in the industry.

### SUMMARY

According to several embodiments of the present disclosure, a shoe upper comprises a non-woven layer. The non-woven layer has an outline pattern and comprises a plurality of yarn segments and a covering structure. The plurality of yarn segments is stacked to form the outline pattern without penetrating through a base layer. Each of the plurality of yarn segments comprises a first end and a second end opposite to each other, wherein the first end and the second end are open ends located at an edge of the outline pattern. The covering structure directly covers the yarn segments and fixes the positions of the plurality of yarn segments, wherein a thickness of the covering structure on each of the plurality of yarn segments ranges from 0.01 mm to 1.5 mm. The non-woven layer has a tensile strength larger than 90 N/cm.

In several embodiments of the present disclosure, the covering structure is disposed between adjacent yarn segments of the plurality of yarn segments, and the covering structure is embedded in at least one of the plurality of yarn segments.

In several embodiments of the present disclosure, every one of the plurality of yarn segments has a plurality of fibers, and the plurality of fibers are elastic fibers.

In several embodiments of the present disclosure, the non-woven layer has a plurality of gaps, an edge of at least one of the plurality of gaps is composed of a surface of at least one of the yarn segments, a surface of the covering structure, or a combination of the surface of at least one of the plurality of yarn segments and the surface of the covering structure.

In several embodiments of the present disclosure, the non-woven layer comprises a lining layer and a surface layer. The plurality of yarn segments comprise a first subset in the lining layer and a second subset in the surface layer, wherein a fineness of the plurality of yarn segments in the first subset is larger than a fineness of the plurality of yarn segments in the second subset.

According to several other embodiments of the present disclosure, a manufacturing method of a shoe upper comprises the following steps: positioning a base layer, wherein the base layer has an outline pattern and a plurality of embroidery points thereon, and the plurality of embroidery points are located on the periphery of the outline pattern; forming a non-woven layer on the base layer using an embroidery thread collection, wherein the embroidery thread collection comprises a yarn material and an adhesive material; and cutting along the outline pattern to detach the base layer and to trim the two ends of each of a plurality of segments of the embroidery thread collection, in order to form a plurality of yarn segments within the outline pattern, wherein every one of the plurality of yarn segments comprises a first end and a second end opposite to each other, and the first end and the second end are open ends located at the edge of the outline pattern. Forming the non-woven layer comprises the following steps: extending the plurality of segments of the embroidery thread collection between the plurality of embroidery points of the base layer and spanning the plurality of segments of the embroidery thread collection across the outline pattern, wherein two ends of each of the plurality of segments of the embroidery thread collection penetrate the base layer through two embroidery points of the plurality of embroidery points respectively to be fixed onto the base layer; performing heat press treatments for the adhesive material to melt to yield melted adhesive material, so that the yarn material in adjacent segments of the plurality of segments of the embroidery thread collection are adhered together; and performing a cold pressing treatments for the melted adhesive material to be cured and form a first covering structure. The first covering structure directly covers the plurality of yarn segments and fixes positions of the plurality of yarn segments. A thickness of the first covering structure on at least one of the yarn segments ranges from 0.01 mm to 1.5 mm. The non-woven layer has a tensile strength larger than 90 N/cm.

In several embodiments of the present disclosure, the step of forming the non-woven layer further comprises: on a surface layer of the embroidery thread collection, positioning a plurality of segments of an adhesive embroidery thread to extend between the plurality of embroidery points of the base layer and span across the outline pattern, wherein two ends of each of the plurality of segments of the adhesive embroidery thread penetrate the base layer through two of the plurality of embroidery points respectively to be fixed on the base layer.

In several embodiments of the present disclosure, the adhesive embroidery thread is melted by the heat press treatment, so as to cover the plurality of segments of the embroidery thread collection and yield a melted adhesive embroidery thread, and the cold pressing treatment makes the melted adhesive embroidery thread be cured to form a second covering structure. A thickness of the second covering structure on at least one of the plurality of yarn segments ranges from 0.01 mm to 1.5 mm.

In several embodiments of the present disclosure, the heat press treatment is performed to let the adhesive materials infiltrate into the yarn material.

In several embodiments of the present disclosure, the melting point of the yarn material is 30° C. to 40° C. higher than the melting point of the adhesive material.

According to the aforementioned embodiments of the present disclosure, through controlling the thickness of the covering structure on the yarn segments within the non-woven layer, the covering structure can not only act serve a method to bond (adhere) yarn segments, but also be used to improve the tensile strength and the bursting strength of the non-woven layer. When the yarn segments of the non-woven layer are stretched, twisted, or bent, the yarn segments will not easily shift aside or become deformed due to the constraint force of the covering structure. Even when the yarn segments have relatively more deformation caused by a substantial sudden stretching force, the yarn segments still can restore to their original positions quickly due to the constraint force of the covering structure. Therefore, the overall structural stability of the shoe upper is improved.

### BRIEF DESCRIPTION OF THE DRAWINGS

To better understand the aforementioned and other objectives, novel features, advantages, and embodiments of the present disclosure, the detailed descriptions of the present disclosure are provided as follows, along with diagrams and preferred embodiments.

FIG. 1 is a two-dimensional structural schematic diagram of the shoe upper according to several embodiments of the present disclosure;

FIG. 2 is a schematic top view of the yarn segments and the covering structure of the non-woven layer described in FIG. 1;

FIG. 3 is a cross-sectional view of the yarn segments and the covering structure of the non-woven layer described in FIG. 1;

FIG. 4 is an image from a scanning electron microscope of the yarn segments and the covering structure according to several embodiments of the present disclosure;

FIG. 5 is a flow chart of the manufacturing method of the shoe upper according to several embodiments of the present disclosure; and

FIG. 6 is a schematic side view of a towel embroidery device according to several embodiments of the present disclosure.

### DETAILED DESCRIPTION

A plurality of embodiments of the present disclosure will be disclosed below with reference to drawings. For the purpose of clear illustration, many details in practice will be provided together with the following descriptions. However, these detailed descriptions in practice are for illustration only, and should not be interpreted to limit the scope, applicability, or configuration of the present disclosure in any way. For better illustration, dimensions of every component in the drawings are not produced according to actual scale. Furthermore, opposite terms, such as “lower” and “upper”, are used in this specification to describe relations of a component with another component. As illustrated in figures, the purpose of opposite terms is to cover components of different directions in addition to the direction that is illustrated. The terms “first” and “second” in the specification and claims are used for specifying different components or to distinguish different embodiments or ranges, and should not be interpreted as the highest value or the lowest value to limit the quantity of the component, or the manufacturing sequence or the sequence of installation of the components.

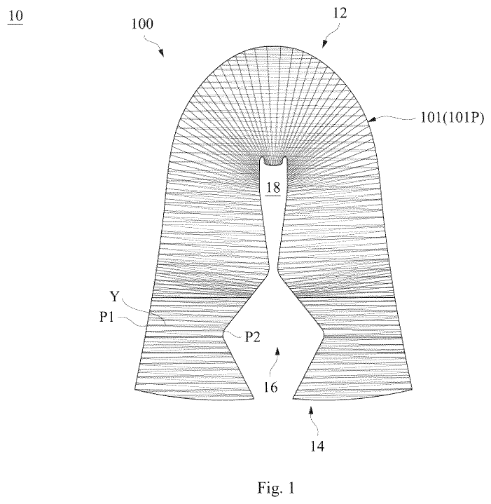

Please refer to FIG. 1, which is a two-dimensional structural schematic diagram of the shoe upper 10 according to several embodiments of the present disclosure. The shoe upper 10 in FIG. 1 can be formed by one single process through the modification of bending, curling, cutting, and hole punching into a surface of footwear products. For example, the shoe upper 10 can be constituted by an upper that wraps around a foot, wherein an upper can comprise a vamp 12, located in the forefoot area and wrapping over toes and the instep, and a quarter 14, located in the hindfoot area and extending from the centerline of the heel to the vamp 12. In addition, the shoe upper 10 surrounds the throat opening 16 and the throat area 18, wherein the throat opening 16 lets the foot enter the inner cavity of shoes, whereas the throat area 18 extends from the throat opening 16 toward the forefoot area and allows the upper to open for aiding the foot into the inner cavity of shoes. In several embodiments, suitable fastening pieces (for example, shoelaces) can extend upward from the side and span across the throat area 18 in order to change the girth of the upper and to firmly keep the foot in the inner cavity within the shoe. The terms “shoes” or “footwear products” in this specification generally refer to any suitable types of covering members or shielding members worn on feet by people.

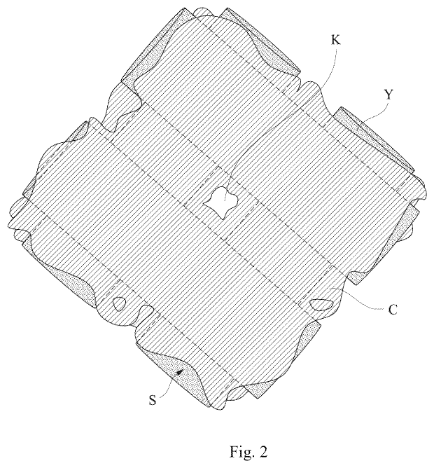

As shown in FIG. 1, the shoe upper 10 of the present disclosure comprises a non-woven layer 100. The term “non-woven layer” in this specification refers to a layer that is not knitted/woven. More specifically, the non-woven layer 100 comprises yarn structures that are not interlocked (for example, woven, knitted, looped, and knotted). The non-woven layer 100 has an outline pattern 101, wherein the outline pattern edge 101P can define the structural boundary between the shoe upper 10 and the shoe sole (not illustrated in the figure) in several embodiments. The non-woven layer 100 comprises a plurality of yarn segments Y and a covering structure C that covers the yarn segments Y and fixes the position of the yarn segments Y (illustrated in FIG. 2). In several embodiments, the non-woven layer 100 further comprises gaps K (illustrated in FIG. 2) surrounded by the covering structure C of the yarn segments Y. Generally, the purpose of the shoe upper 10 is to provide appropriate constraint and protection on the feet of the wearer. Therefore, the goal is to improve the mechanical properties (for example, tensile strength, bursting strength, etc.) of the shoe upper 10, while ensuring wearing comfort (for example, breathability, tactile feel, etc.) of the shoe upper 10. The present disclosure improves the mechanical properties while maintaining necessary comfort, mainly through controlling the thickness of the covering structure C on the yarn segments Y. The following paragraphs will provide detailed descriptions of configurations of the yarn segments Y and covering structure C.

The plurality of yarn segments Y is collectively stacked to form an outline pattern 101 of the non-woven layer 100. In particular, in an observation from the direction perpendicular to the plane of shoe upper 10 (view direction shown in FIG. 1), a plurality of yarn segments Y is crossed/stacked mutually in between at various angles; however, any two yarn segments Y are not mutually locked together and a single yarn segment Y can extend in a straight path along a fixed-direction. Every yarn segment Y extends from and ends at the outline pattern edge 101P of the outline pattern 101. In other words, each of the yarn segments comprises a first end P1 and a second end P2 opposite to each other, wherein the first end P1 and the second end P2 are located at the outline pattern edge 101P of the outline pattern 101. Furthermore, the first end P1 and the second end P2 are open ends. In other words, the first end P1 and the second end P2 are exposed open ends, not connected to any other segments of yarn. Since the plurality of yarn segments Y are configured without being locked mutually, no additional weight from yarn overlap is generated due to interlocking. Hence, in comparison with shoe uppers produced by conventional methods, for example, weaving, knitting, looping, knotting, the shoe upper 10 of the present disclosure has an advantage of be a light-weight feature.

Owing to the conditions for the manufacturing process (which will be explained later), the plurality of yarn segments Y of the non-woven layer 100 can be different segments of the same yarn. Therefore, a plurality of yarn segments Y can have the same yarn type and material. For the yarn types, a yarn segment Y can be a single yarn, composed of a plurality of fibers twisted together around the central axis, or a ply formed by twisting a plurality of single yarns together. For yarn materials, the materials of fibers in the yarn segments Y include cotton, hemp, flax, wool, asbestos, polyester, polyamide, polyurethane, polyether ester, polyolefin, diene, or a combination thereof. It is worth mentioning that the mechanical properties of the shoe upper 10 may be affected by the material compatibility between the yarn segments Y and the covering structure C of the non-woven layer 100. More specifically, when the material compatibility between the yarn segments Y and the covering structure C is higher, the binding force between the yarn segments Y and the covering structure C is higher.

Accordingly; both the former and the latter will not easily fall apart. As a result, the shoe upper 10 has better mechanical properties. According to the above-mentioned basis, the fiber materials in the yarn segments Y preferably include polyurethane, polyether ester, or a combination thereof, in order to complement with materials of the covering structure C (which will be explained later), thereby improving the mechanical properties of the shoe upper 10. On the contrary, since the material compatibility between polypropylene (PP) and materials of the covering structure C is relatively lower, when better mechanical properties of the shoe upper 10 is desired, polypropylene is not an ideal fiber material selected for yarn segments Y. Additionally, before the yarn segments Y are collectively stacked together, the yarn segments Y can be pre-processed to have specific colors, functions, or optimized features, such as treatments of dyeing, water-repellency, or anti-static.

Additionally, considering the need for the shoe upper 10 to have a certain degree of elasticity to withstand foot movements with larger dorsal//plantar flexion angles, in selecting the yarn segments Y, in addition to using general non-elastic yarns, it is preferable to choose the selection of elastic fibers for the yarn segments Y; for example, polyurethane elastic fiber, polyether ester elastic fiber, polyolefin elastic fiber, diene-based elastic fiber, or elastic polyester fiber. The term “elastic fiber” includes the definitions of elastic fiber in “Textile terms and terminology of GB/T 4146-1984” issued by National Standards of Republic of China, including the definitions of polyurethane elastic fiber and polyolefin elastic fiber in “Textiles-Man-made fibers of GB/T 4146.1-2009-Part 1: Generic names” issued by National Standards of Republic of China, the definitions of elastomer issued by American Society for Testing and Materials (ASTM), and the definitions of polyurethane elastic fiber, polyolefin elastic fiber, diene-based elastic fiber, and elastic polyester fiber in “ISO 2076: 2013 (E) Textiles—Man-made fibers—Generic names” issued by INTERNATIONAL STANDARD. In the embodiments that select elastic fibers as the fibers of yarn segments Y, the yarn segments Y can be elastic bare yarns, single layer coated elastic yarns, double layer coated elastic yarns, air covered elastic yarns, or crimped elastic yarns.

The extending direction, distribution pattern, yarn specification, quantity, and proportion of the yarn segments Y can be adjusted according to the functions and requirements of the appearance design of the shoe upper 10 accordingly. For example, the arrangement direction of a part of the yarn segment Y on the shoe upper 10 can be aligned with the expected stretching direction while the shoe upper is in use, so that the yarn segment Y can be stretched along its own stretching axis, which enhances the mechanical strength of the shoe upper 10. Again, for example, to allow the foot to move and bend more naturally in the forefoot area and to have the hindfoot area be covered more steadily, the yarn segments Y with a smaller fineness are used for forming the vamp 12 of the shoe upper 10, and the yarn segments Y with a larger fineness are used for forming the quarter 14 of the shoe upper 10. Furthermore, the fineness of the yarn segments Y from the vamp 12 to the quarter 14 of the shoe upper 10 are designed to gradually increase. In several embodiments, the fineness of the yarn segments Y can be adjusted within the range from 75 denier to 600 denier in order to meet the design standard of high in strength and low in weight. As another example, the non-woven layer 100 comprises yarn segments Y made of relatively softer materials with smaller fineness, and a covering structure C made of relatively harder materials with larger fineness. By increasing the ratio of the yarn segments Y in the vamp 12 (that is, to decrease the ratio of the covering structure C in the vamp 12), the softness and breathability of the vamp 12 increases. By decreasing the ratio of the yarn segments Y in the quarter 14 (that is, to increase the ratio of the covering structure C in the quarter 14), the stiffness of the quarter 14 increases.

In general, the yarn segments Y of the non-woven layer 100 form a multi-layer structure through stacking, so that the overall non-woven layer 100 comprises a lining layer and a surface layer, wherein the lining layer is closer to the foot relatively. The surface layer covers the lining layer along the direction perpendicular to the shoe upper 10 and is closer to the outside, and the lining layer and the surface layer comprise a plurality of yarn segments Y separately. The non-woven layer 100 can have a reinforced structure through the multi-layer design. In several embodiments, yarn segments Y of fineness of a larger denier value (for example, a fineness range from 300 denier to 600 denier) are used for stacking and forming the lining layer of the non-woven layer 100, whereas yarn segments Y of fineness of a smaller denier value (for example, a fineness range from 75 denier to 150 denier) are used for stacking and forming the surface layer of the non-woven layer 100. In other words, the yarn segments Y comprise a first subset in the lining layer and a second subset in the surface layer, wherein the fineness of the yarn segments Y in the first subset is larger than the fineness of the yarn segments Y in the second subset. The non-woven layer 100 hereby can build a layer of high mechanical strength and better tactile feel through the lining layer. Meanwhile, together with a design of a light-weight surface layer formed from the non-woven layer 100, the overall mechanical properties, breathability, and softness of the shoe upper 10 can be achieved.

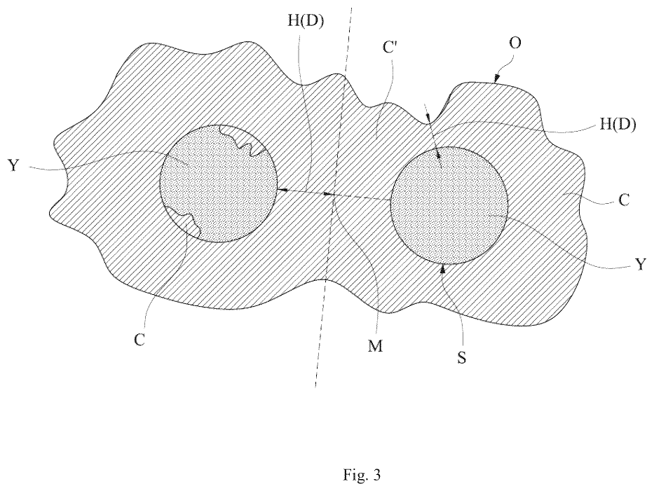

Please refer to FIG. 2 and FIG. 3, wherein FIG. 2 is a schematic top view of the yarn segments Y and the covering structure C of the non-woven layer 100 described in FIG. 1; and FIG. 3 is a cross-sectional view (a cross-section taken radially along the yarn segment Y) of the yarn segments Y and the covering structure C of the non-woven layer 100 described in FIG. 1. The covering structure C, which fixes the position of the yarn segments Y, directly covers the yarn segments Y. More specifically, the covering structure C covers the surface S of the yarn segment Y and spans across a plurality of yarn segments Y to join and fix adjacent yarn segments Y. In several embodiments, the gap between yarn segments Y can be filled with the covering structure C. In other words, the covering structure C is located between any two adjacent yarn segments Y. Through the arrangement of the covering structure C, a plurality of yarn segments Y can be joined to each other and positioned without the need of installing an additional base layer to support the yarn segments Y and to fix the positions of the yarn segments Y. Therefore, the plurality of yarn segments Y of the shoe upper 10 of the present disclosure are not penetrating (threaded) through a base layer. In several embodiments, the coverage ratio of the covering structure C accounts for more than 75% of the total surface area of the yarn segments Y (for example, 75%, 80%, 85%, 90%, 95%, 99%, or 100%). When the coverage ratio of the covering structure C is 100%, it means that the surface S of the yarn segments Y is completely unexposed. Since the covering structure C has a denser structure compared to the yarn segments Y, the coverage ratio of the covering structure C is higher, and the mechanical strength of the shoe upper 10 is greater. However, in order to ensure that the shoe upper 10 is comfortable to wear (for example, breathable, tactile feel, soft, etc.), the coverage ratio of the covering structure C preferably ranges from 75% to 90%.

The covering structure C not only can provide the functions of joining and fixing the yarn segments Y, but also can enhance the mechanical properties of the shoe upper 10 through a proper design of the thickness H. More specifically, adjacent yarn segments Y can form a stable structure through the constraint created by the covering structure C that has an appropriate thickness H. When the yarn segments Y are under the force of stretching, twisting, bending, the yarn segments Y will not shift aside significantly or become deformed due to the constraint force of the covering structure C. Even when the yarn segments Y have relatively more deformation caused by a substantial sudden stretching force, the yarn segments Y still can restore to their original positions quickly due to the constraint force of the covering structure C. Therefore, the overall structural stability of the shoe upper 10 is improved. In other words, in comparison with a layer that is merely composed of a plurality of yarn segments Y stacked together, further adding a covering structure C disposed on the surface S of the plurality of yarn segments Y and in between adjacent yarn segments Y and controlling the thickness H of the covering structure C within a specific range, the non-woven layer 100 that comprises the yarn segments Y and the covering structure C will have better mechanical properties (for example, higher tensile strength, higher bursting strength, etc.).

In particular, when the thickness H of the covering structure C is too small, even though the covering structure C still can join and fix yarn segments Y, the covering structure C cannot provide sufficient constraint force to keep yarn segments Y stable during rapid or intense activities (for example, brisk walking, jumping, running, or sudden stop). When the yarn segments Y and the covering structure C are under the impact of significant external forces, the yarn segments Y and the covering structure C tend to have larger deformation, and may even fracture, break, or fail to maintain effective bonding between the yarn segments Y, resulting in holes in the shoe upper 10, which in turn reduces the lifespan of the shoe upper 10. When the thickness H of the covering structure C is too large, the covering structure C can easily fill up all gaps between the yarn segments Y, making it difficult for the yarn segments Y and the covering structure C to deform even when subjected to larger external forces. This results in the shoe upper 10 becoming too thick, heavy, and rigid, restricting the foot movements. Furthermore, an overly thick, heavy, and rigid covering structure C creates a stuffy and non-breathable space within the shoe that affects the comfort of wearing. In addition, when the thickness H of the covering structure C is too large, the covering structure C can even easily squeeze the neighboring yarn segments Y, causing the overall structure of the non-woven layer 100 to become distorted, resulting in the shoe upper 10 being unable to maintain a stable structure due to uneven force distribution.

Therefore, the thickness H of the covering structure C on the yarn segments Y of the present disclosure is designed to be from 0.01 mm to 1.5 mm (for example, 0.02 mm, 0.04 mm, 0.06 mm, 0.08 mm, 1 mm, 1.2 mm, or 1.4 mm) to ensure that the shoe upper 10 has sufficient mechanical properties to support the load of rapid or intense activities, and to prevent the shoe upper 10 from getting too thick, heavy, difficult to bend, and affecting comfort in wearing during daily activities (for example, daily walk, climbing, tiptoeing, kneeling, and squatting). Please refer to FIG. 3 for explaining the definition and measurement method of the thickness H of the covering structure C. In the present disclosure, take the cross-section of the non-woven layer 100 in any direction to get a cross-sectional view of the yarn segments Y and the corresponding covering structure C, and observe the cross-section by a scanning electron microscope; measure the vertical distance D from the surface S of the yarn segment Y to the outer surface O of the covering structure D in the cross-section; take the smallest distance among all the vertical distances D as the definition of the thickness H of the covering structure C on the yarn segment H of the present disclosure. Furthermore, for calculating the thickness H of the covering structure C′ that is located between and joins two adjacent yarn segments Y, the midpoint is used. In other words, the centerline position of the covering structure C′ (that is, the midpoint M of the shortest connecting line segment between the surfaces S of two yarn segments Y) is used as the boundary reference for measurement boundary for each yarn segment Y. In addition, air bubbles, voids, or other micro-tolerances in the covering structure C created during the production process are negligible when measuring thickness and should not be taken as the boundary reference for measurement.

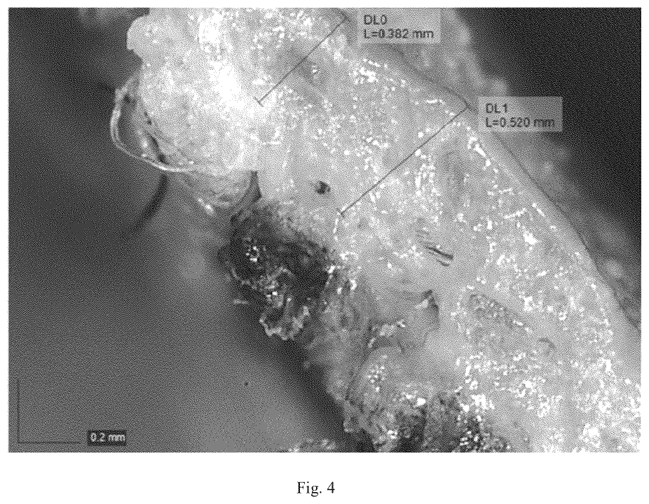

Please refer to FIG. 3 and FIG. 4, wherein FIG. 4 is an image of scanning electron microscope of the yarn segments Y and the covering structure C according to several embodiments of the present disclosure. The image in white color in FIG. 4 is the covering structure C. A value DL0 and a value DL1 are the actual measured vertical distances D from the outer surface O of the covering structure C to the surface S of the yarn segments Y, wherein one vertical distance D from the surface S of one yarn segment Y to the outer surface O of the covering structure C is 0.382 mm (DL0), and the other vertical distance D from the surface S of the other yarn segment Y to the outer surface O of the covering structure C is 0.520 mm (DL1). Both vertical distances do not exceed the maximum thickness of 1.5 mm specified in the present disclosure. Additionally, for the covering structure C located between and joining two yarn segments Y, taking the midpoint as the boundary reference for measuring the distance, the thickness H of the covering structure C on every yarn segment Y will also not exceed 1.5 mm.

The shoe upper 10 of the present disclosure has better mechanical properties at least based on the design of thickness H of the covering structure C. Furthermore, the mechanical properties of the shoe upper 10 can be reflected by the tensile strength of the non-woven layer 100 of the shoe upper 10. More specifically, the non-woven layer 100 of the present disclosure has a tensile strength greater than 90 N/cm, which provides the shoe upper 10 sufficient flexibility (softness) during general activities, frees the wearer from any uncomfortable feeling while wearing the shoes in daily life, and equips the shoe upper 10 with sufficient mechanical properties to support the load of rapid or intense activities. The value of the tensile strength of the non-woven layer 100 is tested and measured by the ASTM D5035-11 standard methods. Additionally, the mechanical properties of the shoe upper 10 can further be reflected by the bursting strength of the non-woven layer 100 of the shoe upper 10. More specifically, the non-woven layer 100 of the present disclosure has a bursting strength greater than 20 kgf/cm². In comparison with the tensile strength, the bursting strength can further reflect the resistance strength of the shoe upper 10 against sudden impact. More specifically, the covering structure C with a specific thickness H helps to bind the neighboring yarn segments Y tightly, allowing the covering structure C and the yarn segments Y to jointly form a protection layer. Additionally, since the covering structure C has enough thickness of H, it can provide good impact resistance. Consequently, when the non-woven layer 100 experiences a sudden impact, the covering structure C and the yarn segments Y that are tightly joined together can generate a rebound-resistance force, thereby preventing the shoe upper 10 from being damaged (breaking). The value of the bursting strength of the non-woven layer 100 is tested and measured by the ISO 13938-2 standard methods.

It is worth mentioning that in conventional techniques within this field there has been no in-depth discussion regarding the correlation and synergistic evaluation between the mechanical properties and comfort in wearing of the shoe upper with a covering structure with a specific thickness. Instead, only generalized methods for bonding yarn segments have been disclosed in the prior art, which fail to meet various functional needs of the actual shoe uppers. Furthermore, conventional techniques in this field have primarily employed methods such as adjusting the alignment of yarn segments, the tension of yarn segments, and the material of yarn segments to improve the mechanical properties of the shoe upper, without specifically directed efforts at optimizing or improving the covering structure. On the other hand, the present disclosure further analyzes the impact of the covering structure on the mechanical properties and overall comfort in wearing of the shoe upper from the microscopic features (thickness) of the covering structure. General descriptions of a specific manufacturing method to produce a covering structure with a thickness ranging from 0.01 mm to 1.5 mm will be provided in the following paragraphs.

Please refer to FIG. 2 and FIG. 3 again. In several embodiments, the covering structure C is further embedded within the yarn segments Y to strengthen the binding force between the covering structure C and the yarn segments Y. By doing so, when the shoe upper 10 is under the force of stretching, twisting, and bending, the probability of the covering structure C and the yarn segments Y detaching from each other is reduced and, as a result, the mechanical strength of the shoe upper 10 is improved.

In several embodiments, the materials of the covering structure C comprise polyurethane, polyether ester, or a combination thereof. More specifically, the polyurethane can be thermoplastic polyurethane (TPU), and the polyether ester can be thermoplastic polyester elastomer (TPEE). The aforementioned materials not only exhibit a good compressive modulus, tensile modulus, and flexural modulus, but also possess high impact strength, so that the mechanical properties of the shoe upper 10 are improved. Furthermore, since the aforementioned materials also have good softness and are wear-resistant, the tactile feel and comfort in wearing of the shoe upper 10 can be achieved at the same time. In other words, when the covering structure C only functions as a means for adhering the yarn segments Y, various thermoplastic polymers or thermosetting polymers (for example, polyester, polyamide, polyolefin, etc.) can be used as the materials of the covering structure C. However, when the mechanical strength provided by the covering structure C is also taken into consideration, polyurethane, polyether ester, or a combination thereof are more preferable as materials for the covering structure C.

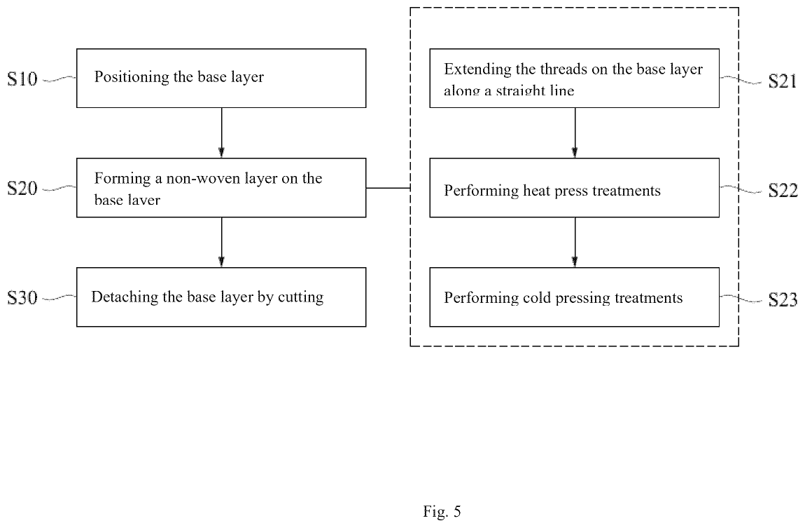

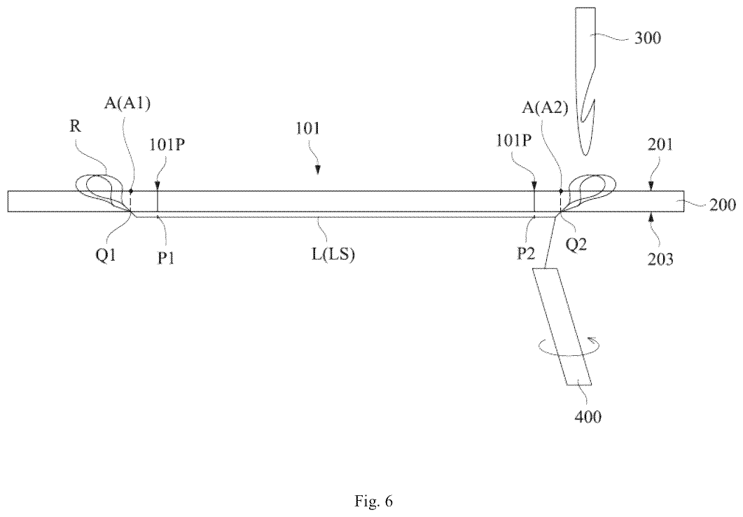

The shoe upper 10 of the present disclosure can be manufactured through embroidery methods (for example, conventional embroidery or towel embroidery). A towel embroidery method (hereinafter referred to as the “embroidery”) is used as an example in the following paragraphs, along with FIG. 1, FIG. 5, and FIG. 6, to explain the shoe upper 10 and manufacturing method thereof of the present disclosure, wherein FIG. 5 is a flow chart of the manufacturing method of the shoe upper 10 according to several embodiments of the present disclosure; and FIG. 6 is a schematic side view of a towel embroidery device according to several embodiments of the present disclosure.

First, in Step S10, position the base layer, wherein the top surface 201 of the base layer 200 has an outline pattern (for example, the outline pattern 101 in FIG. 1) and a plurality of embroidery points A thereon, and the embroidery points A are located on the periphery of the outline pattern 101 without being in contact with the outline pattern 101. In other words, the embroidery points A are located outside the area surrounded by the outline pattern edge 101P of the outline pattern 101. The base layer 200 can be positioned by a positioning component, such as an embroidery frame (not shown in the figures). During the process of embroidery, a needle 300 can pierce through the base layer 200 to hook the embroidery thread L attached to the needle 300, causing the embroidery thread L to pass through the base layer 200 and be fixed onto the base layer 200.

Next, in Step S20, form a non-woven layer 100 on the base layer 200 using the embroidery thread L. More specifically, the steps to form the non-woven layer 100 comprises step S21 to step S23, wherein step S21 to step S23 are carried out in sequence.

In step S21, extend a plurality of segments LS of the embroidery thread L in a straight line between the embroidery points A of the base layer 200 and spanning across the outline pattern 101, wherein both ends (for example, a first end Q1 and a second end Q2) of each segment LS of the embroidery thread L penetrate the base layer 200 through the embroidery points A separately to be fixed on the base layer 200. More specifically, a rotary shuttle 400 located below the bottom surface 203 of the base layer 200 provides embroidery thread L at the first embroidery stitch point A1. Next, the needle 300 located above the top surface 201 of the base layer 200 penetrates the base layer 200 through the first embroidery stitch point A1, and picks up the embroidery thread L to fix one end (for example, the first end Q1) of a segment LS of the embroidery thread L onto the top surface 201 of the base layer 200 through, for example, a knot R. Next, the rotary shuttle 400 pulls the segment LS of the embroidery thread L and makes the segment LS extend from the bottom surface 203 of the base layer 200 straight (along a straight line) to the second embroidery stitch point A2. Next, the needle 300 penetrates the base layer 200 through the second embroidery stitch point A2, and picks up the embroidery thread L again to fix one end (for example, the second end Q2) of a segment LS of the embroidery thread L onto the top surface 201 of the base layer 200 through, for example, a knot R. When the aforementioned moves are completed, a cycle of embroidery is completed. Subsequently, multiple times of embroidery can be performed repeatedly among a plurality of embroidery points A, so that a plurality of segments LS of the embroidery thread L are collectively stacked together to form an outline pattern 101.

For the shoe upper 10 of the present disclosure, the yarn segment Y and the covering structure C can respectively be formed through embroidery. In other words, the embroidery thread L used in the embroidery process can have multiple forms. More specifically, a single embroidery thread L can be a standard yarn including yarn materials used for forming the yarn segment Y, or an adhesive yarn (a fusible yarn) including adhesive materials used for forming the covering structure C, or a composite yarn that comprises both the yarn materials and adhesive materials. In general, an embroidery thread collection comprises the yarn materials and the adhesive materials. Various forms of embroidery thread L can constitute the outline pattern 101 by alternately stacking together through embroidery. Some applicable embodiments are presented below.

In several embodiments, standard yarns and adhesive yarns are used and collectively stacked together to form an outline pattern 101. More specifically, first use standard yarns to perform at least one cycle of embroidery; then use adhesive yarns to perform at least one cycle of embroidery. Perform multiple cycles of the aforementioned embroidery repeatedly, so that standard yarns and adhesive yarns are stacked alternately together to form an outline pattern 101. In several embodiments, the combination methods of standard yarns and adhesive yarns can be adjusted according to the functions and requirements of the appearance design of the shoe upper 10 accordingly. For example, to allow the foot to move and bend more naturally in the forefoot area and make the hindfoot area beg covered more steadily, the proportion of the standard yarns in the vamp 12 of the shoe upper 10 is increased (i.e., decrease the proportion of the adhesive yarns in the vamp), while the proportion of the adhesive yarns in the quarter 14 of the shoe upper 10 is decreased (i.e., increase the proportion of the standard yarns in the quarter). For example, a ratio of two standard yarns to one fusible yarn is used for forming the vamp 12 of the shoe upper 10, while a ratio of one standard yarn matched to one fusible yarn is used to form the quarter 14 of the shoe upper 10. As for the fiber materials of the standard yarns in this embodiment, please refer to the aforementioned fiber materials of the yarn segments Y, and as for the materials of the adhesive yarns, please refer to the aforementioned materials of the covering structure C.

In several embodiments, composite yarns are collectively stacked together to form an outline pattern 101. More specifically, a composite yarn is a ply made of multiple single yarns twisted together, and the ply comprises standard yarns and adhesive yarns. Therefore, using composite yarns for embroidery allows for the simultaneous provision of both the yarn segment Y and the covering structure C in a single embroidery cycle. This eliminates the need to switch threads, thereby simplifying the manufacturing process. In this embodiment, the composite yarns can be core-spun yarns in a form of a standard yarn covering (for example, by wrapping) the adhesive yarn therewithin, or an adhesive yarn covering (for example, by wrapping) the standard yarn therewithin. In this embodiment, for the fiber materials of the standard yarn, please refer to the aforementioned fiber materials of the yarn segments Y, and for the materials of the adhesive yarn, please refer to the aforementioned materials of the covering structure C.

In several embodiments, composite fibers are blended to produce the single yarns (also known as composite fiber yarns) for stacking collectively to form an outline pattern 101. More specifically, a single fiber of a composite fiber yarn is a composite fiber comprising both yarn materials and adhesive materials. Therefore, using composite fiber yarns for embroidery allows for the simultaneous provision of both the yarn segments Y and the covering structure C in a single embroidery cycle. This eliminates the need to switch threads, thereby simplifying the manufacturing process. When the composite fiber yarns are stacked together to form an outline pattern 101 and produce the non-woven layer 100, the covering structure C not only covers the yarn segment Y, but also covers the surface of every fiber segment of the yarn segment Y on a microscopic scale. In other words, the covering structure C is further disposed between adjacent fiber segments of the yarn segment Y to adhere adjacent fiber segments. By doing so, the mechanical strength of the shoe upper 10 can be further improved. In this embodiment, the composite fiber can be a side-by-side fiber, core-sheath fiber, or sea-island fiber, wherein the side-by-side fiber is a fiber comprising the yarn materials and adhesive materials arranged side by side; the core-sheath fiber and the sea-island fiber are fibers comprising a yarn material wrapping an adhesive material therewithin, or an adhesive material wrapping the yarn material therewithin. In this embodiment, for the yarn materials, please refer to the aforementioned fiber materials of the yarn segments Y, and for the adhesive materials, please refer to the aforementioned materials of the covering structure C.

Multiple cycles of embroidery can be performed repeatedly to have a plurality of segments LS of the embroidery thread L collectively stacked together on the top surface 201 of the base layer 200 to form a multilayer structure. In several embodiments, the standard yarn is used in conjunction with the adhesive yarn, composite yarn, composite fiber yarn, or combination thereof to form a multilayer structure through a plurality of embroidery cycles. In several embodiments, a non-woven layer 100 is designed to be formed with a different number of layers in different areas of the shoe upper 10. For example, to allow the foot to move and bend more naturally in the forefoot area and make the hindfoot area be covered more steadily, a non-woven layer 100 with relatively fewer layers is formed as the vamp 12 of the shoe upper 10, whereas a non-woven layer 100 with relatively more layers is formed as the quarter 14 of the shoe upper 10.

In several embodiments, the outermost layer (the layer furthest from the foot, for example, the 18th layer) of the multilayer structure (for example, a structure of 18 layers total) is embroidered entirely or partially using the adhesive yarns, so that the entire surface or partial surface of the non-woven layer 110 is constituted by the covering structure C. In other words, Step S21 of forming a non-woven layer 100 further comprises: extending the plurality of segments LS of the adhesive embroidery thread L on the surface of the embroidery thread collection between the embroidery points A of the base layer 200 along a straight line to cross over the outline pattern 101, wherein both ends (for example, a first end Q1 and a second end Q2) of each segment LS of the adhesive embroidery thread L penetrate the base layer 200 through the embroidery points A separately to be fixed onto the base layer 200. By doing so, the covering structure C made from the cured adhesive yarn can further provide the wrapping strength to the surface of the non-woven layer 100 that improves the mechanical strength of the shoe upper 10. Furthermore, the outermost layer of adhesive yarns formed in the multi-layer structure will melt and become the non-directional covering structure C after the subsequent heat press treatment and cold pressing treatment. Therefore, the stitch direction of the outermost layer of the adhesive yarn formed in the multilayer structure has less relevance with the mechanical strength of the shoe upper 10. Therefore, embroidery can be performed on the adhesive yarns in a single direction directly, thereby improving the efficiency of embroidery.

The shoe upper 10 of the present disclosure manufactured by embroidery can offer a greater design freedom and reduce the cost of materials. For example, materials of the shoe upper 10 (for example, yarn segments Y and covering structure C) are added in a stepwise manner and, therefore, the method is advantageous for changing local material properties and thickness of the shoe upper 10, resulting in optimizing the structure thereof and reducing the waste of off-cuts. Both the yarn segments Y and the covering structure C of the present disclosure can be produced through the same method (that is, embroidery), which increases the convenience in the manufacturing process significantly. In several embodiments, the embroidery stitching speed is about 30 cm/second to balance the embroidery quality and efficiency. On the other hand, the thread tension for embroidery can be adjusted based on the yarns of different materials accordingly, so that the yarns remain taut yet still flexible, in order to balance the comfort in wearing and mechanical strength of the shoe upper 10.

Please refer to FIG. 6. Please note that when the towel embroidery method is used to produce the shoe upper 10, the embroidery thread L extends only on the bottom surface 203 of the base layer 200, whereas the embroidery thread L will not exist in the area surrounded by the outline pattern edge 101P of the outline pattern 101 on the top surface 201 of the base layer 200. Therefore, in comparison with the conventional embroidery that requires the use of both needle (upper) and bobbin (lower) threads that interlock with each other, the towel embroidery can save on thread usage, and there is no need to consider the tension adjustment between the upper and the lower threads, resulting in a significant improvement in convenience in manufacturing processes. Since the conventional embroidery requires the upper thread to interlock with the lower thread, if an elastic yarn is selected as the upper thread, when the upper thread is pulled by the rotary shuttle, the elastic yarn may be over stretched due to its high elasticity, resulting in difficulty in catching the bobbin thread precisely. However, the towel embroidery only requires a single embroidery thread L to complete the process. Therefore, the limitation in selecting the yarn materials of conventional embroidery can be overcame, allowing for the use of more soft and comfortable elastic yarns to produce the shoe upper 10 of the present disclosure.

In Step S22, the heat press treatment is performed to melt the adhesive material and to bond the yarn materials in the adjacent segments LS of the embroidery thread collection. In addition, when the outermost layer of the non-woven layer 100 is further embroidered entirely or partially using the adhesive embroidery thread (adhesive yarn), the heat press treatment also will melt the adhesive embroidery thread in order to cover every segment LS of the embroidery thread collection. The design of using the difference in melting points of the adhesive material and the yarn material, together with the temperature control of the heat press treatment, make the adhesive material having a lower melting point melt during the heat press treatment and ensure that the yarn material having a higher melting point will not melt and maintain its structural strength during the heat press treatment. As a result, the melted adhesive material and the un-melted yarn material are joined together and fixed. In several embodiments, to ensure a sufficient difference in the melting points of the yarn material and the adhesive material, in order to prevent the yarn material from melting due to the temperature fluctuation in the hot press treatment, the melting point of the yarn material (yarn segment Y) is 30° C. to 40° C. higher than the melting point of the adhesive material (covering structure C). Furthermore, when the adhesive material and the yarn material comprise the same material, the adhesive material will infiltrate into the yarn materials through the control of the temperature and pressure of the heat press treatment and form a much stronger bonding force between the yarn materials.

On the other hand, the temperature and pressure of the heat press treatment can influence the melting condition of the adhesive material, thereby affecting the forming of the thickness H of the covering structure C. More specifically, if the temperature and pressure are too high, the adhesive material can spread easily over a large area due to sudden melting or over squeezing. As a result, the overall covering structure C will stretch out to be thin, and the thickness H is too small. If the temperature and pressure are too low, the surface of the adhesive material may not be melted completely to form the covering structure C as designed, causing the covering structure C to be unable to firmly adhere to adjacent yarn segments Y, or the adhesive material may not be properly pressed and spread, resulting in having a large thickness H. Owing to the aforementioned issues, the temperature of the heat press treatment is designed to range from 145° C. to 185° C. (for example, 150° C.); the pressure of the heat press treatment is designed to range from 0.3 MPa to 1.3 MPa; the duration of the heat press treatment is designed to be from 30 seconds to 5 minutes. For example, in terms of design, the heat press treatment can be carried out at a temperature of 150° C. for 1 minute.

In Step S23, the cold pressing treatment cures and shapes the melted adhesive material into the covering structure C. Moreover, when the outermost layer of the non-woven layer 100 is further embroidered entirely or partially using the adhesive embroidery thread (adhesive yarn), the cold pressing treatment also will cure the melted adhesive embroidery thread to shape into the covering structure C. It is worth mentioning that the cold pressing treatment of the present disclosure not only has the function of curing the melted adhesive material, but also can provide the effect of controlling the thickness H of the covering structure C. More specifically, after the heat press treatment, if the melted adhesive material is left to cool down on its own without immediately undergoing cold pressing, or if the cold pressing treatment is not performed adequately, when the subsequent cutting operation is conducted while the adhesive material is not completely cured, the semi-cured adhesive material may shift aside or become thinner while being bent or stretched along with the embroidery thread L, which also affects the thickness H and uniformity of the covering structure C. Additionally, the adhesive material may shift aside and stick to other segments LS of the embroidery thread L, causing positional displacement or distortion in the shape of embroidery thread L. This can further lead to increased spacing or the appearance of additional gaps between adjacent embroidery threads L, thereby reducing the mechanical strength of the shoe upper 10.

On the other hand, the temperature of the cold pressing treatment also can affect the curing of the adhesive material and further affect the thickness H of the covering structure C. More specifically, if the temperature is too high, the adhesive material cannot be cured instantly, causing the adhesive material to easily shift aside or become thinner; if the temperature is relatively low, the cold pressing treatment can be shortened and the adhesive material can be quickly cured without the need for applying a large pressure, which can prevent the adhesive material from being over pressed and becoming thinner. If the temperature is too low and the operational duration lasts too long, the adhesive material will become brittle after curing. In addition, the cold pressing treatment can be operated at a proper pressure to ensure the melted adhesive material is adequately compacted, achieving sufficient structural density while maintaining a certain specific thickness H, and preventing the adhesive material from becoming too thin or brittle due to excessive pressure. Owing to the aforementioned issues, the temperature of the cold pressing treatment is designed to be 0° C. to10° C. (for example, 4° C.); the pressure of the cold pressing treatment is designed to be 0.3 MPa to 1.3 MPa; the duration of the cold pressing treatment is designed to be 10 seconds to 60 seconds.

In addition to the control of temperature and pressure in the heat press treatment and the cold pressing treatment, forming gaps of suitable sizes and quantity within the non-woven layer 100 can improve the breathability, softness, and light-weight feature of the shoe upper 10, and at the same time can provide good buffer effect to the shoe upper 10 when the shoe upper 10 is under impact.

In general, through the operational method of the heat press treatment and the cold pressing treatment in sequence, and through the control of the temperature, pressure, and duration of the heat press treatment and the cold pressing treatment, the desired range of the thickness H (0.01 mm to 1.5 mm) of the covering structure C can be derived. Furthermore, by controlling the tensile strength and the bursting strength of the non-woven layer 100, the mechanical properties of the shoe upper 10 can be improved.

Next, in Step S30, cut along the outline pattern edge 101P of the outline pattern 101 on the base layer 200 to detach the base layer 200 and to trim both ends of each segment LS of the embroidery thread collection, in order to form a plurality of yarn segments Y within the outline pattern 101, wherein every yarn segment Y comprises two ends (for example, a first end P1 and a second end P2) opposite to each other and located on the outline pattern edge 101P of the outline pattern 101 and the two ends are open ends. Since the covering structure C has an appropriate thickness H after the heat press treatment and the cold pressing treatment, the covering structure C can firmly fix the embroidery thread L and ensure that every segment LS of the embroidery thread L will not shrink after the fixed ends (the first end Q1 and the second end Q2) are removed. Therefore, the non-woven layer 100 produced after cutting can maintain its mechanical strength after the cold pressing treatment and before cutting; and the base layer 200 is not required anymore to support the non-woven layer 100. Overall, in the non-woven layer 100, the covering structure C directly covers the yarn segments Y and fixes the position of the yarn segments Y, wherein the thickness H of the covering structure C on the yarn segments Y ranges from 0.01 mm to 1.5 mm. The non-woven layer 100 has a tensile strength greater than 90 N/cm.

Based on the aforementioned embodiments of the present disclosure, by controlling the thickness of the covering structure on the yarn segments within the non-woven layer, the covering structure not only serves as a method to bond (adhere) the yarn segments, but also can be used to improve the tensile strength and the bursting strength of the non-woven layer. When the yarn segments of the non-woven layer are stretched, twisted, or bent, the yarn segments will not easily shift aside or become deformed permanently due to the constraint force of the covering structure. Even when the yarn segments have relatively more deformation caused by a substantial sudden stretching force, the yarn segments still can restore to their original positions quickly due to the constraint force of the covering structure. Therefore, the overall structural stability of the shoe upper is improved.

The above preferred embodiments are presented to disclose the present disclosure, which should not be interpreted to limit the scope, applicability, or configuration of the present disclosure in any way. Those skilled at the art may use any alternative embodiments that are modified or changed without departing from the spirit and scope of the present disclosure and shall be included in the appended claims.

What is claimed is:

1. A shoe upper, comprising:
a non-woven layer having an outline pattern, wherein the non-woven layer comprises:
a plurality of yarn segments collectively stacked to form the outline pattern without penetrating through a base layer, wherein each of the plurality of yarn segments comprises a first end and a second end opposite to each other, and the first end and the second end are open ends located at an edge of the outline pattern; and
a covering structure directly covering the yarn segments and fixing positions of the plurality of yarn segments, wherein a thickness of the covering structure on at least one of the plurality of yarn segments ranges from 0.01 mm to 1.5 mm, and the non-woven layer has a tensile strength larger than 90 N/cm.

2. The shoe upper as claimed in claim 1, wherein the covering structure is disposed between adjacent yarn segments of the plurality of yarn segments, and the covering structure is embedded in at least one of the plurality of yarn segments.

3. The shoe upper as claimed in claim 1, wherein every one of the plurality of yarn segments has a plurality of fibers, and the plurality of fibers are elastic fibers.

4. The shoe upper as claimed in claim 1, wherein the non-woven layer has a plurality of gaps, an edge of at least one of the plurality of gaps is composed of a surface of at least one of the plurality of yarn segments, a surface of the covering structure, or a combination of the surface of at least one of the plurality of yarn segments and the surface of the covering structure.

5. The shoe upper as claimed in claim 1, wherein the non-woven layer comprises a lining layer and a surface layer, the plurality of yarn segments comprise a first subset in the lining layer and a second subset in the surface layer, a fineness of the plurality of yarn segments in the first subset is larger than a fineness of the plurality of yarn segments in the second subset.

6. A manufacturing method of a shoe upper, comprising:
positioning a base layer, wherein the base layer has an outline pattern and a plurality of embroidery points thereon, and the plurality of embroidery points are located on a periphery of the outline pattern;
forming a non-woven layer on the base layer using an embroidery thread collection, wherein the embroidery thread collection comprises a yarn material and an adhesive material, and forming the non-woven layer comprises:
extending a plurality of segments of the embroidery thread collection between the plurality of embroidery points of the base layer and spanning the plurality of segments of the embroidery thread collection across the outline pattern, wherein two ends of each of the plurality of segments of the embroidery thread collection penetrate the base layer through two embroidery points of the plurality of embroidery points respectively to be fixed onto the base layer;
performing a heat press treatment for the adhesive material to melt to yield melted adhesive material, so that the yarn material in adjacent segments of the plurality of segments of the embroidery thread collection are adhered together; and
performing a cold pressing treatment for the melted adhesive material to be cured and form a first covering structure, and
cutting along the outline pattern to detach the base layer and to trim the two ends of each of the plurality of segments of the embroidery thread collection, in order to form a plurality of yarn segments within the outline pattern, wherein every one of the plurality of yarn segments comprises a first end and a second end opposite to each other, and the first end and the second end are open ends located at an edge of the outline pattern,
wherein the first covering structure directly covers the plurality of yarn segments and fixes positions of the plurality of yarn segments, a thickness of the first covering structure on at least one of the plurality of yarn segments ranges from 0.01 mm to 1.5 mm, and the non-woven layer has a tensile strength larger than 90 N/cm.

7. The manufacturing method of the shoe upper as claimed in claim 6, wherein forming the non-woven layer further comprises:
on a surface layer of the embroidery thread collection, positioning a plurality of segments of an adhesive embroidery thread to extend between the plurality of embroidery points of the base layer and span across the outline pattern, wherein two ends of each of the plurality of segments of the adhesive embroidery thread penetrate the base layer through two of the plurality of embroidery points respectively to be fixed on the base layer.

8. The manufacturing method of the shoe upper as claimed in claim 7, wherein the adhesive embroidery thread is melted by the heat press treatment thus to cover the plurality of segments of the embroidery thread collection and yield a melted adhesive embroidery thread, the cold pressing treatment makes the melted adhesive embroidery thread be cured to form a second covering structure, and a thickness of the second covering structure on at least one of the plurality of yarn segments ranges from 0.01 mm to 1.5 mm.

9. The manufacturing method of the shoe upper as claimed in claim 6, wherein the heat press treatment is performed to let the adhesive material infiltrate into the yarn material.

10. The manufacturing method of the shoe upper as claimed in claim 6, wherein a melting point of the yarn material is 30° C. to 40° C. higher than a melting point of the adhesive material.
